(19) United States
(12) Patent Application Publication
(10) Pub. No.: US 2005/0239516 A1
(43) Pub. Date: Oct. 27, 2005

(54) Multi-microphone system for a handheld device

(75) Inventor: Aleksandr L. Gonopolskiy, Southfield, MI (US)

Correspondence Address: BROOKS KUSHMAN P.C., 1000 TOWN CENTER, TWENTY-SECOND FLOOR, SOUTHFIELD, MI, 48075, US

(73) Assignee: Clarity Technologies, Inc., Auburn Hills, MI (US)

(21) Appl. No.: 11/088,291

(22) Filed: Mar. 24, 2005

Related U.S. Application Data
(60) Provisional application No. 60/565,763, filed on Apr. 27, 2004.

(51) Int. Cl. H04M 1/00

(52) U.S. Cl. 455/570; 455/550.1; 455/575.1

(57) ABSTRACT

A handheld phone communication device includes multiple microphones. In a two microphone arrangement, the first microphone is located in any suitable location, while the second microphone is located in a location that provides a signal with significantly lower signal-to-noise ratio, yet with the received signals being not overly obstructed.

### CROSS-REFERENCE TO RELATED APPLICATIONS

This application claims the benefit of U.S. provisional application Ser. No. 60/565,763 filed Apr. 27, 2004.

### BACKGROUND OF THE INVENTION

1. Field of the Invention

The invention relates to handheld devices, and more specifically relates to handheld phone communication devices, such as cellular phones.

2. Background Art

The use of cell phones has become widespread. And in any phone communication system, signal quality is important. Many approaches have been taken to enhance signal quality.

Because signal quality is a significant concern in any phone communication system, there is a need for an improved approach to enhancing signal quality.

### SUMMARY OF THE INVENTION

It is an object of the invention to provide an apparatus in the form of a handheld device for phone communication that employs a multi-microphone system as part of an improved approach to enhancing signal quality for microphone-received signals.

The invention comprehends an approach usable in a phone communication system where a handheld phone communication device (for example, a cell phone or other handheld phone device) includes more than one microphone. A first microphone is located at a traditional microphone location on the handheld phone, while a second microphone is located at a different location.

An important aspect of the invention is the effective positioning of the second microphone. At the more detailed level, the second microphone is located at a position on the handheld phone such that the normal holding of the device by the user does not overly obstruct the reception at the second microphone. There may be multiple possible positions that meet this requirement, and the possibilities vary from device to device depending on device size and shape and typical user grip during phone use. At the same time, the location of the second microphone is also required to be sufficiently dista nt from the first microphone to provide a significantly lower signal-to-noise ratio than the first microphone (which is at the traditional location).

To essentially meet these requirements, the second microphone placement provides a signal with significantly lower signal-to-noise ratio than the first microphone, yet with the received signals being not overly obstructed to preserve the relationship of the signals. Thus, the invention provides a multi-microphone handheld phone communication device with certain physical characteristics.

It is appreciated that embodiments of the invention include handheld devices with more than one microphone, where there is a special relationship between the position of a first microphone and a second microphone. It is further appreciated that embodiments of the invention are not limited to only two microphones.

### BRIEF DESCRIPTION OF THE DRAWINGS

FIGS. 1 and 2 illustrate a preferred embodiment of the invention where the handheld device is a cell phone, and where there are two microphones positioned to provide the required signals.

### DETAILED DESCRIPTION OF THE PREFERRED EMBODIMENT

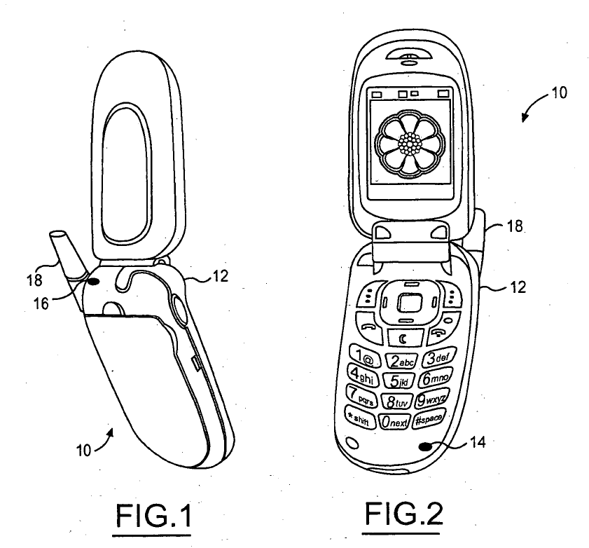

With reference to FIGS. 1 and 2, a handheld phone communication device is illustrated as a cell phone 10. Cell phone 10 has a body 12 and includes the traditional components of the modern cell phone. A first microphone 14 is located at the traditional microphone location on cell phone 10. A second microphone 16 is located near the antenna 18.

These microphone locations exemplify an arrangement of microphones with the special relationship between their positions that provides a second microphone signal with significantly lower signal-to-noise ratio than the first microphone signal, yet with the signal at the second microphone 16 being not overly obstructed to preserve the relationship of the signals.

In this illustrated embodiment, the second microphone 16 would not be overly obstructed by the normal holding of the cell phone 10 by the user during phone use.

With continuing reference to the preferred embodiment illustrated in FIGS. 1 and 2, the second microphone placement is in a beneficial location. The first microphone 14 appears roughly where the single microphone goes in a typical single microphone cell phone. However, the second microphone 16 needs to provide a signal with significantly lower signal-to-noise ratio, yet without too much obstruction. In the preferred embodiment, a location for the second microphone 16 immediately adjacent to the antenna stalk 18 of the cell phone 10 meets these requirements.

In this particular arrangement, the proximity of the antenna 18 to the second microphone 16 makes it difficult for the user to accidentally cover the microphone 16 with his/her finger. Further, the distance of the second microphone 16 from the first microphone 14 is sufficient to provide the different signal-to-noise ratios.

It is appreciated that embodiments of the invention provide a handheld phone communication device with certain physical characteristics and with a special relationship between first and second microphones. It is further appreciated that embodiments of the invention are not limited to only two microphones.

It is further appreciated that the invention comprehends a special relationship between the positions of the first and second microphones on handheld devices for phone communication, and implementations and embodiments of the invention are not restricted to any particular arrangements for other aspects of the devices.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An apparatus comprising:
a handheld device for phone communication, the handheld device having a multi-microphone system including a first microphone located at a traditional microphone location on the handheld device and a second microphone located at a different location on the handheld device; and
wherein the second microphone is located sufficiently distant from the first microphone to provide a significantly lower signal-to-noise ratio than provided by the first microphone, and wherein the second microphone is located at a position on the handheld device such that the normal holding of the device by the user does not overly obstruct the reception at the second microphone, thereby preserving the relationship of the received microphone signals.

2. The apparatus of claim 1 wherein the handheld device has exactly two microphones.

3. The apparatus of claim 1 wherein the handheld device is a cell phone.

4. The apparatus of claim 1 wherein the handheld device further includes an antenna stalk, and wherein the second microphone is located near the antenna stalk.

5. The apparatus of claim 4 wherein the second microphone is located immediately adjacent to the antenna stalk, and wherein the proximity of the antenna stalk to the second microphone makes it difficult for the user to accidentally cover the second microphone when holding the handheld device.

6. A method comprising:
providing a handheld device for phone communication, the handheld device having a multi-microphone system including a first microphone located at a traditional microphone location on the handheld device and a second microphone located at a different location on the handheld device; and
wherein the second microphone is located sufficiently distant from the first microphone to provide a significantly lower signal-to-noise ratio than provided by the first microphone, and wherein the second microphone is located at a position on the handheld device such that the normal holding of the device by the user does not overly obstruct the reception at the second microphone, thereby preserving the relationship of the received microphone signals.

7. The method of claim 6 wherein the handheld device has exactly two microphones.

8. The method of claim 6 wherein the handheld device is a cell phone.

9. The method of claim 6 wherein the handheld device further includes an antenna stalk, and wherein the second microphone is located near the antenna stalk.

10. The method of claim 9 wherein the second microphone is located immediately adjacent to the antenna stalk, and wherein the proximity of the antenna stalk to the second microphone makes it difficult for the user to accidentally cover the second microphone when holding the handheld device.
